(19) United States
(12) Patent Application Publication
(10) Pub. No.: US 2010/0268405 A1
(43) Pub. Date: Oct. 21, 2010

(54) METHOD FOR INFORMING A DRIVER ABOUT A CAPABILITY OF AN ELECTRIC MOTOR IN A VEHICLE TO OUTPUT A MINIMUM POWER ABLE TO BE REQUESTED

(76) Inventor: Herbert Prickarz, Fellbach (DE)

Correspondence Address: KENYON & KENYON LLP, ONE BROADWAY, NEW YORK, NY, 10004, US

(21) Appl. No.: 12/733,838

(22) PCT Filed: Aug. 27, 2008
(86) PCT No.: PCT/EP2008/061171

§ 371 Date: Jun. 10, 2010

(30) Foreign Application Priority Data
Sep. 26, 2007 (DE) 102007046222.2

(51) Int. Cl. G06F 17/00

(52) U.S. Cl. 701/22

(57) ABSTRACT

In a method for informing a driver of a vehicle about a capability of an electric motor in the vehicle to output a minimum power able to be requested by the driver, a variable display of a display element is implemented depending upon whether the requestable minimum power is able to be provided by the electric motor over a specifiable period of time.

### BACKGROUND OF THE INVENTION

1. Field of the Invention

The present invention relates to a method and a control device for informing a driver about a capability of an electric motor in a vehicle to output a minimum power able to be requested by the driver.

2. Description of Related Art

Methods are known for informing a driver about a capability of an electric motor in a vehicle to output a power, in which with the aid of an indicator, the driver is informed about the energy available in an energy accumulator of the electric motor. Such an indication is usually made by displaying the state of charge of the energy accumulator of the electric motor. An indication such as this may be made via a needle instrument. If the driver is informed about the state of charge of the energy accumulator of the electric motor, it is possible for him to estimate a maximum performance of the vehicle drive in the form of the electric motor. In the older, not yet published German Patent Application DE 102007012305.3, it is described that a driver is informed about the instantaneous maximum performance of the vehicle drive. If the driver knows the maximum performance of the vehicle drive, it is possible for him to take this into account when planning or executing a driving maneuver like, for example, a passing maneuver.

### BRIEF SUMMARY OF THE INVENTION

In contrast, the method of the present invention for informing a driver of a vehicle about a capability of an electric motor in the vehicle to output a minimum power able to be requested by the driver has the advantage that a variable display of a display element is implemented, depending upon whether the requestable minimum power is able to be provided by the electric motor over a specifiable period of time.

Vehicles with a vehicle drive having an electric motor are known. For example, such a vehicle drive may have an electric motor as the only motor. Vehicle drives in the form of hybrid drives are also familiar, in which a combustion engine and an electric motor contribute to the output of the vehicle drive. To carry out driving maneuvers such as passing maneuvers, for instance, it is possible that short-term for a certain period of time, the driver may want to access a minimum power of the vehicle drive, which is higher than the instantaneously generated power of the vehicle drive. A minimum power output is thereby needed through the electric motor of the vehicle drive as well, which requires a minimum power output of the energy accumulator of the electric motor. Such an energy accumulator of an electric motor, chiefly in the form of a battery, by preference may be provided in the form of a high-voltage battery. If only the state of charge of the energy accumulator is displayed to the driver, then the period of time over which he may access a minimum power of the vehicle drive is not directly evident to him, since as a rule, he does not know the exact relationship between the state of charge of the energy accumulator and the characteristic of the power input of the electric motor as a function of the minimum power requested of the vehicle drive. If the driver requests a minimum power of the vehicle drive in order to carry out a driving maneuver, it is advantageous for him to know whether this minimum power is able to be made available over a first specifiable period of time, about which, according to the present invention, he is informed by a variable display of a display element.

Such a specifiable period of time is preferably a minimum period of time of a certain number of seconds. For example, it could be a period of time of 30 seconds, or perhaps 60 seconds. The driver is thus informed about whether he is able to access the minimum power of the vehicle drive over the specifiable period of time, thereby enabling him to better plan a possible driving maneuver, resulting in increased safety in road traffic. In this way, the break-off of the minimum power requested by the driver in a manner that is sudden and unexpected for him is prevented during the execution of the driving maneuver.

The display element is preferably shown as a function of a period of time over which the requestable minimum power is able to be made available at the maximum by the electric motor. This is advantageous, since the driver is thereby informed not only about whether the minimum power is able to be provided over a specifiable period of time, but is also able to estimate whether the period of time over which the requestable minimum power is able to be provided at the maximum by the electric motor is greater than the specifiable period of time.

Preferably, the period of time over which the requestable minimum power is able to be provided at the maximum by the electric motor is displayed. This is advantageous, since the driver is thereby informed about the exact period of time over which the requestable minimum power is able to be provided at the maximum by the electric motor, so that he is able to more exactly plan the execution of a possible driving maneuver. In particular, it is possible that the requestable minimum power may only be requested through an input by the driver when the requestable minimum power is able to be provided at least over the specifiable period of time. This is advantageous, since the driver may only request the minimum power by an input in order, for example, to carry out a driving maneuver, when this minimum power is also able to be provided over the specifiable period of time. The driver is thereby prevented from requesting the minimum power when it is only able to be provided for a very brief period of time.

If the minimum power is requested by the driver at a first point in time, and if at this first point in time, the minimum power is only able to be provided at the maximum over a period of time which falls short of the specifiable period of time, and if at a second later point in time, the period of time over which the minimum power is able to be provided at the maximum is at least equal to the specifiable period of time, then preferentially, this is displayed to the driver. This is advantageous, since in the event that the driver requests the minimum power at a first point in time, but it cannot be provided at least over the specifiable period of time, the driver is informed at a later second point in time that the minimum power is now able to be provided at least for the specifiable period of time. This yields the advantage that after a futile request for the minimum power, the driver is informed at a later point in time that he may now access this minimum power, at least over the specifiable period of time, so that he may execute a driving maneuver, e.g., a passing maneuver, possibly planned.

If a driver requests the minimum power, and this minimum power is provided by an electric motor, then in the event that while the minimum power is being provided, the period of time over which the requestable minimum power is able to be provided at the maximum by the electric motor falls short of a second specifiable period of time, this is indicated to the driver. This is advantageous since, in the case when the driver, in the course of carrying out a driving maneuver, accesses the minimum power, and the period of time over which the minimum power can continue to be provided at the maximum falls short of a second specifiable period of time, the driver is informed that the minimum power is available for only a very limited time, so that, for example, he will alter or break off a driving maneuver, especially a passing maneuver.

The control device of the present invention for controlling a display unit to inform a driver of a vehicle about a capability of an electric motor in the vehicle to output a minimum power able to be requested by the driver likewise has the aforementioned advantages of the method according to the present invention.

### BRIEF DESCRIPTION OF THE SEVERAL VIEWS OF THE DRAWING

FIGS. 1a, 1b, 2a, 2b, 3a, 3b, 3c, 4a, 4b and 4c show variable displays of a display element according to different respective example embodiments of the present invention.

FIGS. 5a and 5b show variable displays of a display element in the joint display of a period of time over which the requestable minimum power is able to be provided at the maximum by the electric motor, according to respective different exemplary embodiments of the present invention.

FIGS. 6a and 6b show displays according to respective further exemplary embodiments of the present invention, with whose aid it is indicated to the driver that during the provision of the minimum power, the period of time over which the requestable minimum power is able to be provided at the maximum by the electric motor falls short of a second specifiable period of time.

FIG. 7 shows a control device of the present invention for controlling a display unit.

FIGS. 8, 9 and 10 each show a control device according to respective further exemplary embodiments of the present invention.

### DETAILED DESCRIPTION OF THE INVENTION

If a driver is driving a vehicle which has an electric motor as part of the vehicle drive, it is possible that in the course of carrying out a driving maneuver, e.g., a passing maneuver, the driver will request a minimum power from the vehicle drive which is higher than the instantaneous output of the vehicle drive. In order to be able to safely plan and carry out such a driving maneuver, it is crucial that the driver know whether the minimum power requested by him is able to be provided over a specifiable period of time. The driver is then able to estimate whether the vehicle drive is able to provide the minimum power over a period of time which is sufficient for executing the driving maneuver. Therefore, according to the present invention, a variable display of a display element is implemented depending upon whether the requestable minimum power is able to be provided by the electric motor over a specifiable period of time.

Preferably, the specifiable period of time is permanently set, it being a numerical value of, e.g., 30 seconds, 60 seconds or perhaps 120 seconds. Moreover, preferentially, it is possible that the driver himself presets this specifiable period of time, which means he is informed by the variable display of the display element about whether the minimum power is able to be provided over a period of time which corresponds to his preference.

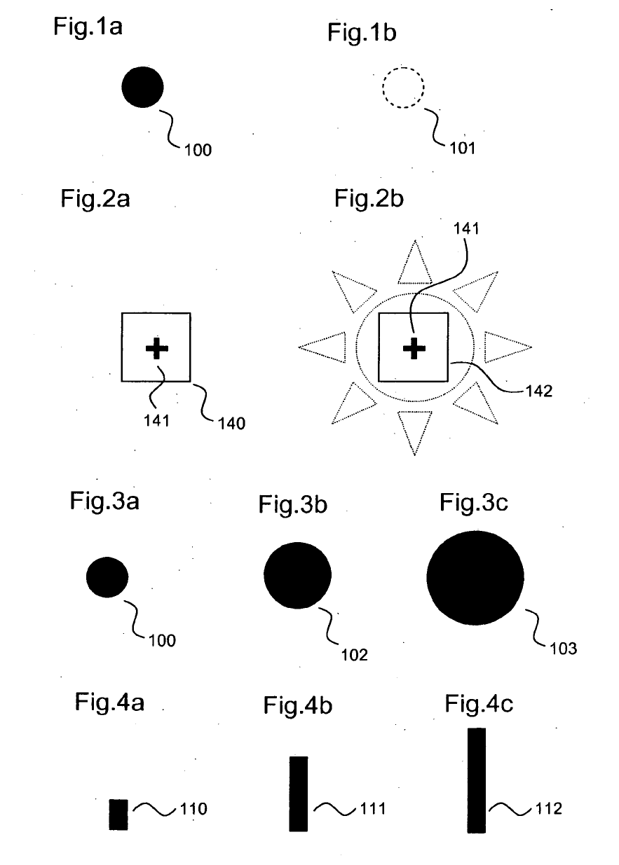

According to one exemplary embodiment, the variable display of the display element is implemented as shown in FIGS. 1a and 1b. According to one exemplary embodiment, FIG. 1a shows a display element in the form of a circle 100, and FIG. 1b shows a circle 101 which is drawn with dashes. In the case when the requestable minimum power is able to be provided over the specifiable period of time, preferably circle 100 is displayed. In the event that the minimum power is unable to be provided over the specifiable period of time, preferably dashed circle 101 is displayed. Thus, it is easily possible for the driver to recognize whether he may access the requestable minimum power over the specifiable period of time. Instead of dashed circle 101, preferably it is possible to display a circle in shaded form. Moreover, it is possible within the course of the display of display elements 100, 101, preferably to access symbols which differ from each other due to different colorings and/or shape designs.

FIGS. 2a and 2b show a variable display of a display element 140, 142 according to a further exemplary embodiment. Preferably, the display element is provided in the form of a backlighted plastic element 140. This plastic element 140 able to be backlighted preferably has a symbol 141, which the driver associates with a minimum power able to be requested. If the requestable minimum power is unable to be provided over a specifiable period of time, according to this exemplary embodiment, plastic element 140 is not backlighted, as depicted in FIG. 2a. For the case when the requestable minimum power is able to be made available over the specifiable period of time, plastic element 142 is backlighted according to the exemplary embodiment; as depicted in FIG. 2b.

In addition to the exemplary embodiments of the variable display of a display element shown in FIGS. 1a, 1b, 2a and 2b, further displays of a display element are conceivable; for example, they include LCD displays, warning lights, a head-up display or perhaps a central display in the area of the center console of a vehicle.

The display element is preferably shown as a function of a period of time over which the requestable minimum power is able to be made available at the maximum by the electric motor. Exemplary embodiments for this are given in FIGS. 3a, 3b and 3c.

FIG. 3a shows a circle 100 which indicates to the driver that the minimum power is able to be provided over the specifiable period of time. FIG. 3b shows a second circle 102 which is larger than first circle 100. FIG. 3c shows a third circle 103 which is larger than first circle 100 and second circle 102. Preferably, the display of circle 100, 102, 103 is carried out in such a way that the size of circle 100, 102, 103 is proportional to the period of time over which the requestable minimum power is able to be provided at the maximum.

According to a second exemplary embodiment in FIGS. 4a, 4b and 4c, the display of the display element is in the form of a bar 110, 111, 112.

FIG. 4a shows a first bar 110. FIG. 4b shows a second bar 111, which is larger than first bar 110. FIG. 4c shows a third bar 112, which is larger than first bar 110 and larger than second bar 111. According to this exemplary embodiment, the size of the display of bar 110, 111, 112 is proportional to the period of time over which the requestable minimum power is able to be provided at the maximum. Preferably, it is possible to use other symbols or representation forms for the representation of the display element. Moreover, it is possible to fall back upon different colorings for the variable display of the display element as a function of the period of time over which the requestable minimum power is able to be provided at the maximum. The display element is preferably a lever or a pointer, which assumes a position as a function of the period of time over which the requestable minimum power is able to be provided at the maximum.

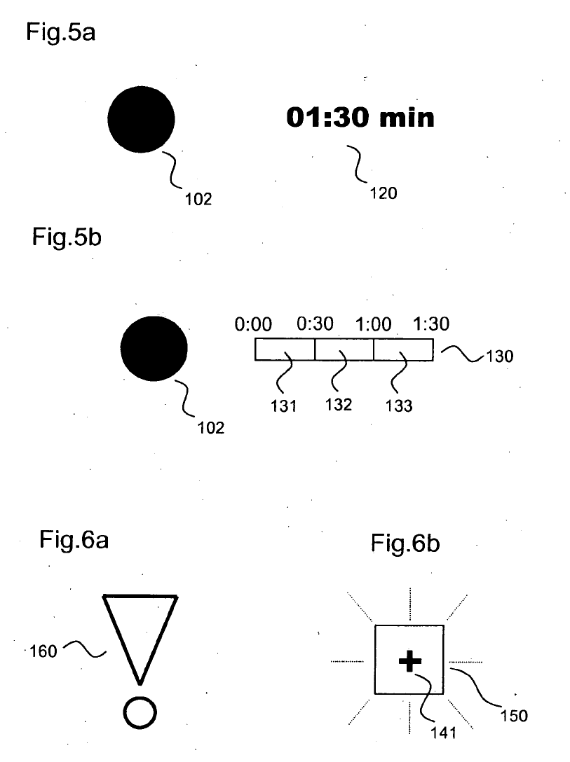

According to a further exemplary embodiment of the present invention, the period of time over which the minimum power is able to be provided at the maximum is displayed. Exemplary embodiments for this are shown in FIGS. 5a and 5b. FIG. 5a shows in a circle 102, which is displayed to the driver, that the minimum power is able to be provided over the specifiable period of time. In addition, FIG. 5a shows a time display 120, which displays a time of one minute and 30 seconds. According to this exemplary embodiment, display 120 indicates to the driver that he is able to access the minimum power of the electric motor over a period of time of 1 minute and 30 seconds. FIG. 5b shows a further exemplary embodiment for the display of the period of time. According to FIG. 5b, circle 102 is displayed, by which the driver is informed that he may access the minimum power of the electric motor over a specifiable period of time. For example, according to this exemplary embodiment, the specifiable period of time is a time duration of 30 seconds. FIG. 5b also shows a bar 130, which is made up of a first bar segment 131, a second bar segment 132 and a third bar segment 133. According to this exemplary embodiment, the period of time over which the minimum power is able to be provided at the maximum is displayed by bar 130. First bar segment 131 symbolizes the period of time from 0 to 30 seconds, second bar segment 132 symbolizes the period of time from 30 seconds to 1 minute, and third bar segment 133 symbolizes the period of time from 1 minute to 1 minute and 30 seconds. By the display of all three bar segments 131, 132, 133, the driver is informed that he is able to access the minimum power over a period of time of 1 minute and 30 seconds. Further forms of a display, like time displays 120, 130 shown here for displaying the period of time over which the requestable minimum power is able to be provided at the maximum, are conceivable, for example, in the form of clock symbols, variably displayable circle segments or other display forms for representing times.

Preferably, the minimum power able to be requested may only be requested through an input by the driver when the minimum power is able to be provided at least over the specifiable period of time. For example, if a driver starts a passing maneuver and does not inform himself beforehand, by observing the variable display, as to the period of time over which the minimum power requested by him is able to be provided, then there is the danger that in the course of a driving maneuver carried out by him, the minimum power will suddenly and unexpectedly break off, so that the vehicle performance no longer corresponds to the performance estimated by him. If, according to the exemplary embodiment, the minimum power is only made available when it is also able to be provided over the specifiable period of time, then the driver may be confident that in the course of providing the minimum power, it will also be provided at least over the specifiable period of time.

For example, it is possible that in a driving situation, the driver may want to request the minimum power. However, if this minimum power is unable to be provided over the specifiable period of time, then the request for the minimum power is preferably denied to the driver. If, at a second later point in time, the energy accumulator of the electric motor has sufficient energy so that the electric motor is able to provide the requestable minimum power at least over the specifiable period of time, preferably this is indicated to the driver. For instance, if while driving with his vehicle on a turnpike, the driver finds himself behind a truck and would like to pass this truck by requesting the minimum power of the electric motor, it is possible, for example, that the battery of the electric motor will not have sufficient energy to permit the electric motor to provide the minimum power over the specifiable period of time. Therefore, for example, the request for the minimum power is denied to the driver, so that he is not tempted to initiate the passing maneuver, since the minimum power could possibly break off unexpectedly in the course of executing the passing maneuver. If, for instance, the driver is now driving for a longer time behind the truck, then it is possible, for example, that the battery of the electric motor may recuperate, so that at a second later point in time, the electric motor is again able to provide the minimum power over the specifiable period of time, thus making it possible to execute the passing maneuver. Preferably, this is indicated to the driver. This indication is preferably made to the driver by an optical display element. By preference, it is a separate display element. It is also possible, for example, to make this indication by an acoustic indicator, preferably a warning signal.

If the driver would like to access the minimum power able to be requested, according to the present invention, a variable display of a display element indicates to the driver whether the requestable minimum power is able to be provided over a specifiable period of time. If this is the case, and if, after the request by the driver, the minimum power able to be requested is provided by the electric motor, there is the possibility, for instance, that while the minimum power is being provided, the energy available through the energy accumulator of the electric motor could change. For example, this could cause a decrease in the period of time over which the minimum power is able to be provided at the maximum. In order for the driver, in the course of a driving maneuver, thus, while the minimum power is being provided, to be made aware of an imminent absence of the minimum power, in the event that during the provision of the minimum power, the period of time over which the requestable minimum power is able to be provided at the maximum by the electric motor falls short of a second specifiable period of time, this is preferably indicated to the driver. Such an indication is preferably made by a warning symbol lighting up and/or blinking, which by preference, is shown in a display unit or implemented in the form of a warning light.

Exemplary embodiments of such a display are given in FIGS. 6a and 6b. FIG. 6a shows an exclamation mark, which preferably is displayed on an LCD display. If there is a drop below the specifiable period of time, exclamation mark 160 preferably lights up. Display element 160 is preferably displayed with the aid of special coloring which the driver sees as a warning, e.g., in the form of the car color red. In the same way, it is preferably possible to show display element 160 blinking. In particular, the drop below the second specifiable period of time is indicated by a sole and/or additional acoustic indicator, e.g., in the form of a warning signal. FIG. 6b shows a warning light 150 that preferably has a symbol 141. In particular, the drop below the second specifiable period of time is indicated to the driver by a blinking and/or lighting up of warning light 150. In addition, the drop below the second specifiable period of time is preferably indicated by an acoustic indicator, e.g., a warning signal.

The second specifiable period of time is preferably set permanently to a value, e.g., a value of 10 seconds. The second specifiable period of time is preferably independent of the first specifiable period of time. Moreover, the second specifiable period of time is preferably able to be set by the driver. The driver thereby decides himself about, for instance, how long the second period of time before an absence of the minimum power is which must be undershot, so that the driver is warned prior to the absence of the minimum power.

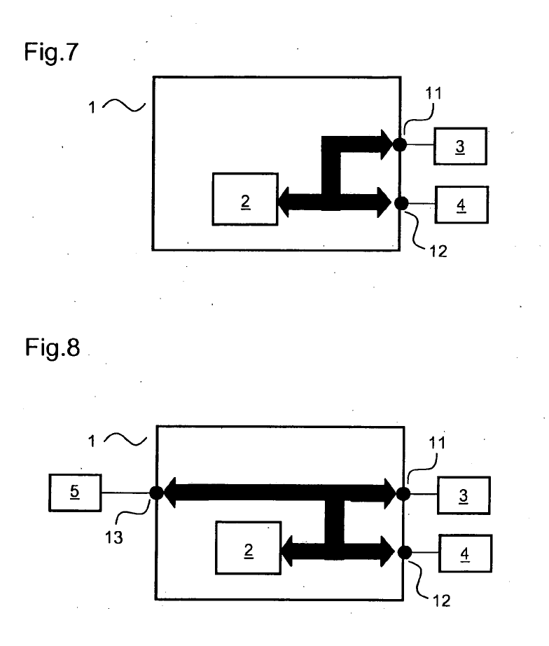

FIG. 7 shows the control device of the present invention for controlling a display unit to inform a driver of a vehicle about a capability of an electric motor in the vehicle to output a minimum power able to be requested by the driver.

Control device 1 according to the present invention has an arithmetic logic unit 2 as well as a first interface 11 to a display unit 3 and a second interface 12 to an energy accumulator 4 of an electric motor of a vehicle. Control device 1 of the present invention is characterized in that control device 1 controls display unit 3 in such a way that a variable display of a display element is implemented as a function of whether the requestable minimum power is able to be provided by the electric motor over a specifiable period of time. To that end, control device 1 accesses energy accumulator 4 of the electric motor via second interface 12 and measures, for example, the state of charge of energy accumulator 4. Furthermore, via interface 12, control device 1 preferably determines an operating temperature of energy accumulator 4. The preferable determination of the operating temperature is advantageous in the case of an automotive battery, for instance, since the capability of a battery to supply a power is dependent on temperature. Further characteristic quantities of energy accumulator 4 may preferably be determined by control device 1 via interface 12. The characteristic quantities of energy accumulator 4 determined are evaluated in control device 1 by arithmetic logic unit 2, so that based on this evaluation of the characteristic quantities, arithmetic logic unit 2 deduces a period of time over which a requestable minimum power is able to be provided at the maximum by the electric motor. To that end, by preference, it is possible that arithmetic logic unit 2 has knowledge about characteristic curves of the electric motor which preferably are available in the form of a software module or, for instance, are made available by a memory unit (not shown here) of control device 1. Via first interface 11, control device 1, with the aid of arithmetic logic unit 2, controls a variable display of a display element as a function of whether the requestable minimum power is able to be provided by the electric motor over a specifiable period of time. Display element 3 is preferably an LCD display, a warning light, a plastic element able to be backlighted, a head-up display or a central display in the area of the center console of the vehicle.

FIG. 8 shows control device 1 according to a further exemplary embodiment of the present invention. In addition to the units and interfaces already shown in FIG. 7, control device 1 according to FIG. 8 has a third interface 13 via which control device 1 is connected to an input unit 5. This input unit 5 is suitable for the request by the driver for the minimum power of the electric motor able to be requested. Preferably, input unit 5 is a button on the steering wheel or a button in the area of the center console of the vehicle. Further forms of input unit 5 for the request by the driver for the minimum power are possible, for instance, in the form of a touchscreen or in the form of a sensor on the gas pedal.

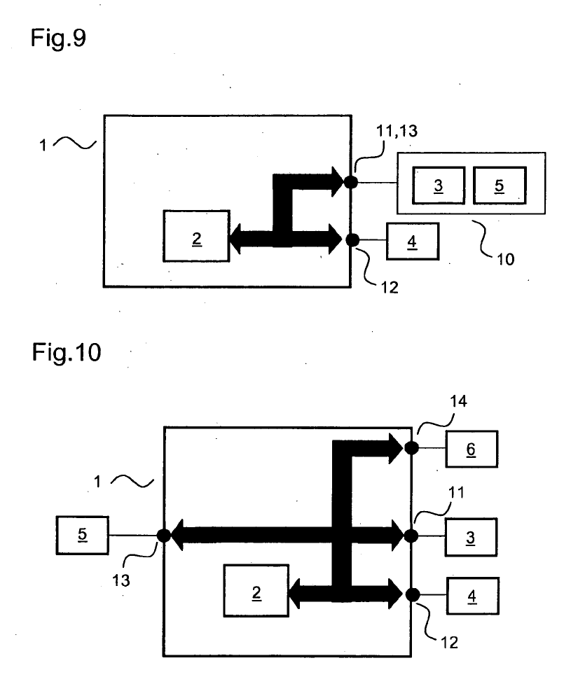

FIG. 9 shows a control device 1 according to another exemplary embodiment of the present invention. Control device 1 has arithmetic logic unit 2 as well as a second interface 12 to energy accumulator 4 of the electric motor. According to this exemplary embodiment, first interface 11 and third interface 13 are implemented as a joint interface that results in a combined unit 10 in which display unit 3 and input unit 5 take the form of a joint combined unit 10. By preference, this combined unit 10 may be a button via which the driver may request the minimum power, the button preferably being backlighted when the requestable minimum power is able to be provided over a specifiable period of time. According to this exemplary embodiment, combined unit 10 makes it possible for the driver to concentrate on this one combined element 10 both for checking the variable display of the display element and for inputting a request for the minimum power.

FIG. 10 shows a control device 1 according to a further exemplary embodiment of the present invention. According to this exemplary embodiment, control device 1 additionally has a fourth interface 14 to an acoustic output unit 6. With the aid of arithmetic logic unit 2, control device 1 preferably controls acoustic output unit 6 via fourth interface 14, in order to output a warning signal. By preference, such a warning signal is output in the event that, while the minimum power is being provided, the period of time over which the requestable minimum power is able to be provided at the maximum by the electric motor drops below a second specifiable period of time. An output of an acoustic warning signal by arithmetic logic unit 2 via fourth interface 14 with the aid of acoustic output unit 6 is also possible, for example, for further cases when the driver should be made aware. Acoustic output unit 6 is preferably a loudspeaker, a buzzer, an alarm horn or another unit for the output of an acoustic signal.

1-8. (canceled)

9. A method for informing a driver of a vehicle about a capability of an electric motor in the vehicle to output a minimum power able to be requested by the driver, comprising:
providing a variable display of a display element depending upon whether the minimum power is able to be provided by the electric motor over a first specified period of time.

10. The method as recited in claim 9, wherein the display element is displayed as a function of a period of time over which the minimum power is able to be provided at the maximum by the electric motor.

11. The method as recited in claim 10, wherein the period of time over which the minimum power is able to be provided at the maximum by the electric motor is displayed.

12. The method as recited in claim 9, wherein the minimum power is able to be requested through an input by the driver only when the minimum power is able to be provided at least over the specified period of time.

13. The method as recited in claim 12, wherein (a) if at a first point in time at which the minimum power is requested by the driver, the minimum power is able to be provided at the maximum over a period of time which is shorter than the specified period of time, and (b) if at a subsequent second point in time, the period of time over which the minimum power is able to be provided at the maximum is at least equal to the specified period of time, indicating condition (b) to the driver.

14. The method as recited in claim 12, wherein in the event that while the minimum power is being provided, the period of time over which the minimum power is able to be provided at the maximum by the electric motor falls short of a second specified period of time, providing an indication of the existence of the shortfall to the driver.

15. A control device for controlling a display unit to inform a driver of a vehicle about a capability of an electric motor in the vehicle to output a minimum power able to be requested by the driver, comprising:
an arithmetic logic unit;
a first interface to the display unit; and
a second interface to an energy accumulator of the electric motor of a vehicle;
wherein the control device controls the display unit to provide a variable display of a display element depending upon whether the minimum power is able to be provided by the electric motor over a specified period of time.

16. The control device as recited in claim 15, further comprising:
a third interface to an input unit for the driver to request the minimum power from the electric motor.
